(19) United States
(12) Patent Application Publication
(10) Pub. No.: US 2003/0105794 A1
(43) Pub. Date: Jun. 5, 2003

(54) Systems for sensing similarity in monitored broadcast content streams and methods of operating the same

(76) Inventors: Radu S. Jasinschi, Ossining, NY (US); Lalitha Agnihotri, Fishkill, NY (US); John Zimmerman, Ossining, NY (US)

Correspondence Address: Corporate Patent Counsel, U.S. Philips Corporation, 580 White Plains Road, Tarrytown, NY, 10591, US

(21) Appl. No.: 09/991,242

(22) Filed: Nov. 9, 2001

(51) Int. Cl. G06F 7/00

(52) U.S. Cl. 709/1

(57) ABSTRACT

There are disclosed systems for sensing similarity in monitored broadcast content streams and methods of operating the same. According to an exemplary embodiment, a monitoring system is introduced that is capable of identifying content similarity within a plurality of broadcast content streams, each of the plurality of broadcast content streams having detectable content attributes, the monitoring system operable to (i) monitor the plurality of broadcast content streams, and (ii) compare a first segment and a second segment of at least one broadcast content stream to identify select-similar broadcast content within the segments as a function of ones of the detectable content attributes.

### CROSS-REFERENCE TO RELATED APPLICATION

The present invention is related to those disclosed in U.S. patent application Ser. No. [Docket No. 701483], filed concurrently herewith, entitled “SYSTEMS FOR MONITORING BROADCAST CONTENT AND GENERATING NOTIFICATION SIGNALS AS A FUNCTION OF SUBSCRIBER PROFILES AND METHOD OF OPERATING THE SAME” The above application is commonly assigned to the assignee of the present invention. The disclosure of this related patent application is incorporated by reference for all purposes as if fully set forth herein.

### TECHNICAL FIELD OF THE INVENTION

The present invention is directed, in general, to broadcast content systems and, more specifically, to systems for sensing similarity in monitored broadcast content streams and methods of operating the same.

### BACKGROUND OF THE INVENTION

The ability to analyze large amounts of received broadcast video, audio and textual content data in order to find relevant segments (e.g., clips, sound bytes, slices, portions, sections, sub-components, etc.) is extremely important in contemporary as well as anticipated video, audio and data processing applications.

For instance, in interactive television, pay-per-view and other like systems, subscribers (e.g., users, customers, viewers, clients, etc.) want to see sections of movies, shows and other performance content before renting or purchasing the same. Similarly, in professional and scholastic environments, digital video, audio and data libraries increasingly operate to collect and disseminate moving image, audio and other interactive material. Many engineers, computer scientists, attorneys, accountants, doctors, scholars, including political scientists, psychologists and historians, study interactive and moving video and audio as primary source material.

Whether in the consumer, professional or scholastic environment, there exists an need for improved systems for detecting content of interest and to analyze such material. With the advent of the Internet and the exponential increase in cable, satellite, time-shifted viewing and the like, the viewer is has ever-increasing sources of publicly broadcast content and therefore to the airing of similar content of interest to the subscriber. There is a need in the art for improved systems that can sense similar content broadcast within content streams as well as means for communicating select similar content to subscribers.

### SUMMARY OF THE INVENTION

To address the above-discussed deficiencies of the prior art, it is a primary object of the present invention to provide systems for sensing similarity in monitored broadcast content streams and methods of operating the same. According to an exemplary embodiment, a monitoring system is introduced that is capable of identifying content similarity within a plurality of broadcast content streams, each of the plurality of broadcast content streams having detectable content attributes and being any of television (e.g., traditional, cable, satellite, etc.), radio, Internet or other broadcast content stream.

The monitoring system is operable to (i) monitor the plurality of broadcast content streams, and (ii) compare a first segment and a second segment of at least one broadcast content stream to identify select-similar broadcast content within the segments as a function of ones of the detectable content attributes. This select-similar broadcast content may suitably be identified using retrieved metadata, select data retrieved from a proprietary or third-part data repository, select data retrieved over the Internet, or the like. The phrase “select-similar broadcast content,” as used herein, is defined broadly to include any defined application to identify “Live Alerts” (e.g., any public alarms and emergency warnings, local, regional, national, or international events (e.g., special event), similar content, updating/modifying stored content (including deleting redundant content), or the like.

For instance, an exemplary “Live Alert” embodiment may suitably be operable to detect select-similar broadcast “Live Alert” content on at least one broadcast content stream when such content is not expected (e.g., public alarms; emergency warnings; local, regional, national, or international events (e.g., political, economic, social, government, etc.), any event that is of interest to a user/subscriber, user/subscriber group or user/subscriber type). A related invention that utilizes the teachings of this patent document is disclosed in co-pending U.S. patent application Ser. No. [Docket No. 701483], filed concurrently herewith, entitled “SYSTEMS FOR MONITORING BROADCAST CONTENT AND GENERATING NOTIFICATION SIGNALS AS A FUNCTION OF SUBSCRIBER PROFILES AND METHOD OF OPERATING THE SAME,” and previously incorporated by reference for all purposes as if fully set forth herein.

With respect to identifying similar content, the embodiments of the present invention may be operable to identify similar content, such as finding multiple television programs having a substantially similar genre. With respect to updating/modifying stored content, the embodiments of the present invention may be operable to store and update data concerning a developing news story, such as a Presidential race, a terrorist act, a sporting event, or the like.

An important aspect hereof is that broadcast content similarity may suitably be detected in a single broadcast content stream (analysis may be among temporally disparate broadcast content segments within a single broadcast content stream), as well as across a plurality of broadcast content streams. Similarity detection may advantageously be accomplished using at least one of visual data, audio data and transcript data, ones of which may be associated with each of the broadcast content streams.

For instance, visual data may illustratively be gleaned from a cut rate, a color histogram, motion data, object data, or the like; audio data may illustratively be gleaned from sound effects, speech patterns, noise patterns, music patterns, or the like; and transcript data may illustratively be gleaned from translations speech-to-text data (whether in summarized form or otherwise), closed-caption data, embedded-text data, video-screen-text data, or the like.

According to a related implementation, the principles of the present invention may be associated with a suitably arranged appliance comprising a receiver and a monitoring system. The receiver is capable of receiving broadcast content streams from at least one of a plurality of sources. The monitoring system is capable of identifying content similarity within a plurality of broadcast content streams, wherein each of the broadcast content streams has detectable content attributes. The monitoring system is operable to (i) monitor the plurality of broadcast content streams, and (ii) compare a first segment and a second segment of at least one broadcast content stream to identify select-similar broadcast content within the segments as a function of ones of the detectable content attributes.

According to a related embodiment, the monitoring system is further operable to generate a control signal as a function of the identified select-similar broadcast content, the generated control signal directing operation of the appliance. According to a further related embodiment, the appliance is capable of operating in one of an active mode and a standby mode and, when the appliance is operating in the standby mode, the generated control signal directs the appliance to switch from standby mode to active mode.

The foregoing has outlined rather broadly the features and technical advantages of the present invention so that those skilled in the art may better understand THE DETAILED DESCRIPTION OF THE INVENTION that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the terms “controller” and “processor” mean any device, system or part thereof that controls at least one operation, such a device may be implemented in hardware, firmware or software, or some combination of at least two of the same. It should be noted that the functionality associated with any particular controller/processor may suitably be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a detailed block of an exemplary monitoring system in accordance with one embodiment of the present invention;

FIG. 2 illustrates a block diagram of an exemplary appliance operable to identify select-similar broadcast content within the segments of one or more broadcast content streams in accordance with one embodiment of the present invention; and

FIG. 3 illustrates a flow chart of an exemplary method of operating a monitoring system for identifying select-similar broadcast content within the segments one or more broadcast content streams and then controlling an associated appliance in accordance with one embodiment of the present invention.

### DETAILED DESCRIPTION OF THE INVENTION

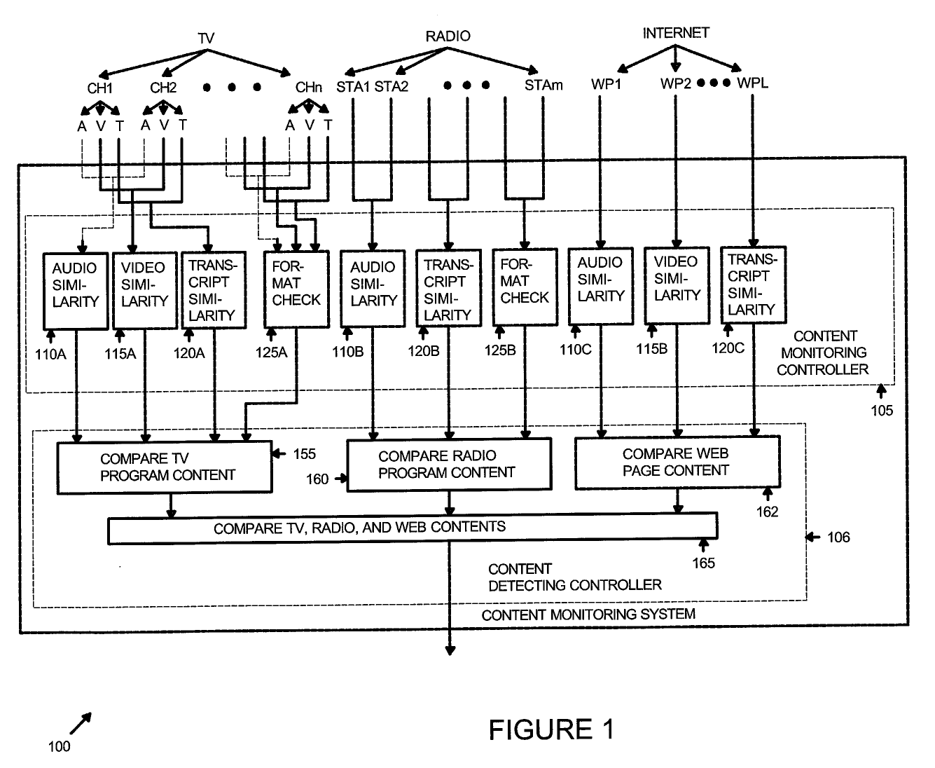

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged content broadcast system.

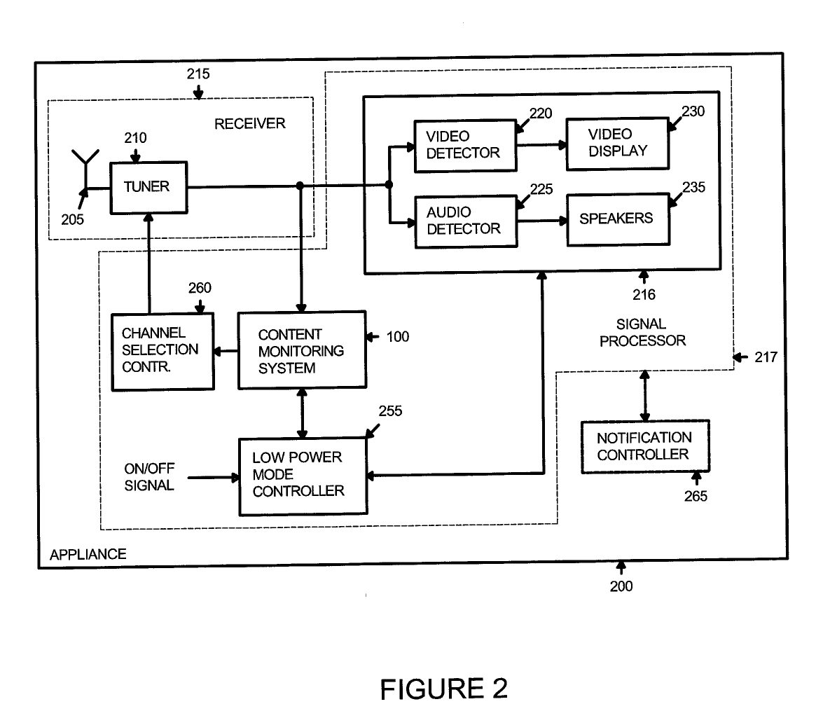

FIG. 1 illustrates a detailed block diagram of an exemplary content monitoring system (generally designated 100) in accordance with one embodiment of the present invention. Exemplary content monitoring system 100 is provided for use in an appliance (shown in FIG. 2; e.g., television, set top box, computer (e.g., handheld, laptop, desktop, computer network, etc.), or the like) comprising a receiver capable of receiving broadcast content streams. Broadly, content monitoring system 100 operates to monitor a plurality of broadcast streams (e.g. channels, stations, etc.) and, in response to sensing changes in broadcast content, to identify select-similar broadcast content within segments at least one such monitored broadcast channel as a function of detectable content attributes.

The ability to sense changes generally in broadcast content is known in the art. The deficiencies of the art are found in identifying “select” sensed content changes, which, according to the present invention, is accomplished as a function of detected content attributes. Select-similar broadcast content is determined on an application by application basis, and, for instance, may include identification of “Live Alerts,” similar content, updating/modifying stored content (including deleting redundant content), or the like.

The content attributes may therefore be detected directly from the monitored broadcast channels (e.g., cut rates, color histograms, motion data, object data, sound effects, speech patterns, noise patterns, music patterns, speech-to-text translation data (whether in summarized form or otherwise), closed-caption data, embedded-text data, video-screen-text data, etc.), or indirectly from any suitable data repository, select data retrieved over the Internet or the like, including, for instance, some metadata.

Content monitoring system 100 comprises a content monitoring controller 105 and a content detecting controller 106. Broadly, exemplary content monitoring controller 105 monitors the plurality of broadcast content streams. Content monitoring controller 105 is more specifically operable to (i) receive the plurality of broadcast content streams from at least one receiver, (ii) monitor the plurality of received broadcast content streams, and (iii) sense content changes in the plurality of received broadcast content streams as a function of the detectable content attributes.

Exemplary content detecting controller 106 broadly processes the sensed content changes, comparing a first segment and a second segment of at least one broadcast content stream to identify select-similar broadcast content within the segments as a function of ones of the detectable content attributes. Content detecting controller 106 is more specifically operable to identify a defined set of select broadcast content as a function of ones of the detectable content attributes associated with the select broadcast content.

According to the illustrated embodiment, (i) if the select broadcast content were possibly a “Live Alert,” content detecting controller 106 identifies the defined set of select broadcast content as unscheduled broadcast content that preempts scheduled broadcast content (e.g., distinguishing between normal and preempting content changes, and, when an preempting content change is identified, to determine whether the preempting content change is tolerable or within tolerance—a local weather event, a Presidential race, a terrorist act, a sporting event, etc.); and (ii) if the select broadcast content were possibly “similar” content, content detecting controller 206 identifies the defined set of select broadcast content as substantially similar to a prior defined set of select broadcast content (whether from temporally disparate segments of a single broadcast content stream or across multiple broadcast content streams).

According to a related embodiment, if the select broadcast content were “similar” content, and the application/implementation was further operable to update/modify stored content (including the functionality of deleting redundant content), content detecting controller 206 is further operable to (i) maintain the prior defined set of select broadcast content in memory and (ii) modify the prior defined set of select broadcast content as a function of the defined set of select broadcast content.

Returning to FIG. 1, exemplary content monitoring controller 105 illustratively comprises audio similarity processors 110A to 110C, video similarity processors 115A to 115B, transcript similarity processors 120A to 120C, and format-check processors 125A to 125B. Exemplary content detecting controller 106 illustratively comprises a compare television program content processor 155, a compare radio program content processor 160, a compare web page content processor 162, and a compare television, radio and Internet program content processor 165.

According to the illustrated embodiment, monitoring system 100 is capable of identifying content similarity within two or more segments of at least one of a plurality of broadcast content streams (e.g., television channels, radio stations, Internet websites, etc.), wherein each of the plurality of broadcast content streams has detectable content attributes. Exemplary audio similarity processors 110A to 110C, video similarity processors 115A to 115B, transcript similarity processors 120A to 120C, and format-check similarity processors 125A to 125B respectively receive broadcast content streams television channels CH1 to CHn, radio stations STA1 to STAn, and Internet websites WP1 to WPn, though other sources of broadcast content are possible and within the scope this invention. Audio similarity processors 110A to 110C, video similarity processors 115A to 115B, transcript similarity processors 120A to 120C, and format-check similarity processors 125A to 125B operate to monitor these received broadcast content streams and sense content changes therein as a function of the detectable content attributes.

According to the illustrated embodiment of content monitoring controller 105, the content data of each of the television, radio and Internet broadcast content streams are separately processed. This is accomplished by processing:

(a) the audio content data, the video content data and the transcript content data of all television channels, as well as performing a suitable format check;

(b) the audio content data and the transcript content data of all radio channels, as well as performing a suitable format check; and

(c) the audio content data, the video content data and the transcript content data of all web page content,

in separate similarity/format processors 110 to 125. It will be understood by those skilled in the art that any suitable combination of similarity processors may be implemented and suitably used to monitor received broadcast content streams and sense content changes therein as a function of the detectable content attributes.

For purposes of illustration, it is assumed that the present application/implementation is directed toward identifying similar content wherein two or more broadcast content streams (e.g., television channels, radio stations, Internet websites, etc.) may suitably carry similar select broadcast content. As is evident from FIG. 1, content monitoring system 100 is operable to monitor a plethora of content streams broadcast across multiple television channels, radio stations, web pages, etc. illustrating an ability to “tune” into multiple streams concurrently.

The ability of content monitoring system 100 to at least one of watch, listen, perceive, or otherwise monitor broadcast content streams and identify similar content is also of value to analyze temporally disparate segments of at least one stream to gather and update information concerning a particular event, subject, etc. It should be noted that if a single stream is repeating, that is, the same content is being repeated, separate temporal segments of the stream may suitably be thought of as two channels.

Exemplary content monitoring controller 105 may employ any suitably arranged sensing methodology to compare segments with one another, or, alternatively, to a known pattern, profile, model, outline, characteristic, or other measurable delineation of desired content for which similar content is sought.

To monitor the audio domain of broadcast content streams, it is desirable to use at least one of timbre, pitch, frequency, etc. to determine audio coherence between different content stream sources (e.g., commonly more effective if not dealing with audio of television presenters, if an audio signal is external to a television station (presenters) audio signal, the inter-channel audio coherence may suitably be more effectively measured).

To monitor the video domain of broadcast content streams, it is desirable to use at least one of color, motion, shape, texture information, etc. to determine visual coherence between (i) temporally disparate images of the same content stream source (e.g., television channel), and (ii) images associated with different content stream sources. Exemplary techniques that may be used include DEJA VIDEO™, color super-histograms, etc.

An important element of these techniques is to determine at which “level” visual coherence performed. For instance, assuming a robust scene cut detection method, key frames may be captured and matched (e.g., matching DCT coefficients, etc.). System 100 will measure a whole shot, including w.r.t color, motion, shape, texture information, etc., and then compare these measures inter-“channelly.” The generation of measures of visual similarity inter-“channelly” is endless and any approach is therefore within the scope of the present invention

To monitor the textual domain of broadcast content streams, it is desirable to use at least one of closed captioning (CC), text transcripts, etc. to match the semantic content of a segment of a content stream with others being broadcast. Assuming the monitoring of a television channel, the textual information may be either external and internal to the channel. Multiple television channels may be monitored for broadcasting the “same” topic (i.e., underlying semantic textual information is measurably very similar), similar key words are used—when a “shooting” occurs, the name of the school, place etc. are repeated on all channels.

For purposes of an example, it is assumed that the present application/implementation is directed toward identifying “Live Alerts” wherein many broadcast content streams carry a similar content report concerning the same event. Exemplary content monitoring controller 105 may suitably employ the following sensing methodologies, including:

Monitor audio of broadcast content streams for emergency broadcast tone, for instance, for a local emergency, broadcasters often play this tone before important information is transmitted.

Monitor video broadcast for known “faces” appearing in different content streams, for instance, President Bush addressing the nation being on all channels.

Monitor television broadcast for a “ticker” at the bottom of the screen. A ticker is an area where scrolling text often appears. Television broadcasters use this as a method of passing on important information (e.g., thunderstorm warnings, tornado watch, etc.) without preempting the currently broadcast show.

Monitor transcript of a “ticker” for words such as warning, emergency, danger, disaster, etc.

Convert broadcast audio to text and monitor for keywords such as “warning”, “emergency”, “danger”, “disaster”, etc., to determine if a suspected preempted show is important enough to interrupt viewers.

Monitor closed caption or other text services for words such as “warning”, “emergency”, “danger”, “disaster”, etc., to determine if a suspected preempted show is important enough to interrupt viewers.

Monitor for absence of closed captioning or other text services in content that usually has text, as closed captioning currently is only available for either recorded programs or planned live broadcasts such as scheduled news show and sporting events, when a breaking news story preempts a regularly scheduled shows, the closed caption data is usually not available.

Monitor video, audio, and transcript for a high rate of content repetition, when important events happen, commentators restate the situation frequently to bring viewers who are just tuning in up to speed.

Monitor the format of a broadcast content stream and check to see if it matches the expected format for either the content scheduled in the EPG or for the show previously broadcast on this day and time. Checking this information can help determine if a content scheduled has been preempted, as preempting often indicates a significant event. The format includes for instance to the following:

Time spacing pattern commercials appearing within the program. When important events happen, the commercial breaks often decrease or are eliminated.

A super-histogram is a chart of color information within a show. Most shows have a distinctive look that creates a unique super-histogram. The system can also check to see if the current super-histogram matches super-histograms of other significant events.

Most shows have a fairly consistent cut rate or pattern of edits throughout the show. Noticing a change, especially a large reduction in the cuts can help determine if a show has been preempted.

It should be noted that the foregoing presents an example of one method of sensing similarity in monitored broadcast content streams using a “Live Alert” environment. Those skilled in the art will understand that any combination of suitably arranged monitoring methodologies may be employed to address any defined similarity that is sought to be matched. Similarity matching may be undertaken at any of a range of levels, including, for instance, interpreting the content (e.g., audio, visual, textual, etc.) by accumulating the same into higher-level data clusters, generating high-level multimedia records as a function of the same, or the like, and then comparing the foregoing at an inter-channel level.

Exemplary content detecting controller 106, in response to the foregoing analysis, is operable to compare a first segment and a second segment of at least one broadcast content stream to identify select-similar broadcast content within the segments as a function of ones of the detectable content attributes. Again, according to the present embodiment, content detecting controller 206 more particularly identifies the defined set of select broadcast content as unscheduled broadcast content that preempts scheduled broadcast content (e.g., distinguishing between normal and preempting content changes, and, when an preempting content change is identified, to determine whether the preempting content change is tolerable or within tolerance—a local weather event, a Presidential race, a terrorist act, a sporting event, etc.) thereby enabling monitoring system 100 to verify the presence of a “Live Alert.” The “Live Alert” is accordingly detected as a function of comparing a content change sensed between a first segment of one received broadcast content stream and a second segment of either the same or on another one of the broadcast content streams.

FIG. 2 illustrates an exemplary appliance 200 which is operable to identify select-similar broadcast content within the segments of one or more broadcast content streams in accordance with one embodiment of the present invention. For the purposes of simplicity in explaining the operation of the present invention, the description that follows is directed toward an embodiment in which the present invention is implemented in a television 200. However, this is by way of illustration only.

It should be clearly understood that the present invention may be implemented in any device that includes at least one of a radio, a television, an Internet, or like receiver, including, for example, a television set, a stereo system, a conventional AM/FM radio in an automobile, set-top box for association with a television, a personal computer (PC) equipped with an tuner card/modem capable of receiving radio, television, Internet broadcast content streams among other devices.

Exemplary television 200 comprises a receiver 215, a signal processor 217 and a notification controller 265. Exemplary receiver 215 may be any device operable to receive broadcast content, whether radio, Internet, television (e.g., standard, satellite, cable, etc.) or otherwise. For purposes of illustration, receiver 215 includes an antenna 205 and a tuner 210. Exemplary signal processor 217 comprises an intermediate frequency standby mode circuitry 216, a content monitoring system 100, a low power mode controller 255, and a channel selection controller 260. Exemplary notification controller 265 is operable to provide notification indicia to a subscriber of the identification of a special event, and may suitably include an audio indicator (e.g., speaker, siren, etc.), a visual indicator (e.g., light, LED display, etc.), a means for communicating the identification of similar content to the subscriber via a communication device (e.g., pager, cellular telephone, Web-enabled PDA or other suitable mobile device, etc.), or the like. According to this embodiment, television 200 is capable of operating in an active mode and a standby mode, the standby mode may advantageously operate in low-power consumption.

Under normal operating conditions, the ON/OFF status of television 200 is controlled by an operator using either a remote control or a manual switch to generate an ON/OFF signal that controls low power mode controller 255. Except for standby mode circuitry 216, the indicated circuits of television 200 operate and receive electrical power when power has been disabled (i.e., placed in the standby mode by enabling the “OFF” signal through the ON/OFF switch).

Antenna 205 receives broadcast content streams from television broadcast stations, radio broadcast stations, Internet Websites, and the like. Antenna 205 transfers these broadcast content streams to tuner 210. Even when television 200 is in standby mode, tuner 210 down converts select frequency channels of the received broadcast content stream to video, audio and other signals that are processed in standby mode circuitry 216 and monitored by content monitoring system 100. With respect to data received via the Internet, the broadcast content stream is received as data packets.

Standby mode circuitry 216 comprises the portions of television 200 that are required for the video and audio conversion of received signals. Standby mode circuitry 216 includes video detector 220, audio detector 225, video display 230, and speakers 235. Video detector 220 and audio detector 225 convert the baseband signals to video signals and audio signals that are sent to video display 230 and audio speakers 235, respectively. Video display 230 provides means for viewing the received broadcast image(s) and speakers 235 provide the audio output associated with the received signals. In an alternate radio embodiment of the present invention, standby mode circuitry 216 may only comprise audio circuits providing the functions of a radio receiver.

The ON/OFF status of standby mode circuitry 216 is controlled by low power mode controller 255. Standby mode circuitry 216 is fully “ON” or operational when low power mode controller 255 is enabled by the ON/OFF switch or by content monitoring system 100 upon detection of select-similar broadcast content. Otherwise, standby mode circuitry 216 is in the “OFF” (or standby) mode.

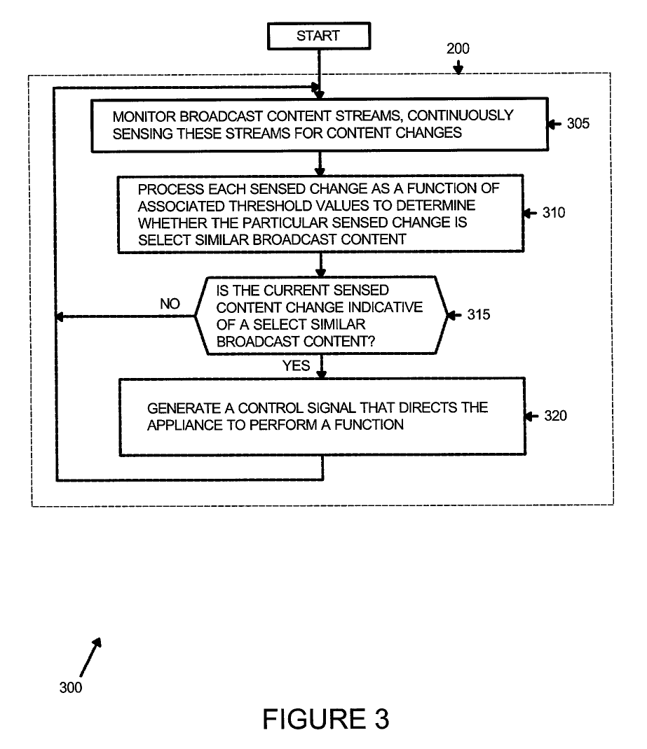

FIG. 3 illustrates a flow chart of an exemplary method (generally designated 300) of operating content monitoring system 100 in accordance with one embodiment of the present invention. For purposes of illustration, the discussion of FIG. 3 is made with concurrent reference to FIGS. 1 and 2 (it is apparent to those skilled in the art that the introduction of a multi-mode appliance 200 is illustrative of one advantageous embodiment of the present invention).

In operation, monitoring system 105 operates to repeatedly sense change in the detectable content attributes of received broadcast content streams (process step 305). More specifically, audio-visual transcript similarity processors 110, 115; audio transcript similarity processors 120, 125; and Web page content similarity processor 130 receive the plurality of broadcast content streams (e.g., television, radio, Internet, etc.). Audio-visual transcript similarity processors 110, 115; audio transcript similarity processors 120, 125; and Web page content similarity processor 130, along with television programming format check processors 135, 140; and radio programming format check processors 145, 150 monitor and sense content changes in the received broadcast content streams as a function of the detectable content attributes as described hereinabove.

Content detecting controller 106 operates to process each sensed change as a function of ones of the detectable content attributes to determine whether a particular sensed change is select-similar broadcast content (process step 310). Again, depending upon the implementation, the select-similar broadcast content may be identified as a “Live Alert,” similar content, updated/modified content (including deleting redundant content), or the like.

More specifically, compare television program content processor 155, a compare radio program content processor 160, and a compare television, radio and Internet program content processor 165 illustratively operate to cooperatively compare temporally disparate segments within a single broadcast stream as well as segments within multiple broadcast streams to identify select-similar broadcast content within the segments as a function of ones of the detectable content attributes.

According to this embodiment, ones of the sensed changes are processed as a function of associated threshold values to determine whether the change is within tolerance (i.e., has not exceeded a threshold). It should be noted that the one or more associated thresholds may be statically or dynamically represented. The sophistication of any such representation may be as complex or as uncomplicated as needed by a given application. It should further be noted that any representation may be set initially to, or reset to, a default value.

If content detecting controller 106 determines that a particular content change is select-similar broadcast content (“Y” branch of determination step 315), then content monitoring system 100 generates a control signal directing associated appliance 200 to perform a particular function (process step 320). More specifically, if the select broadcast content were a “Live Alert,” content detecting controller 106 identifies the defined set of select broadcast content as unscheduled broadcast content that preempts scheduled broadcast content (e.g., distinguishing between normal and preempting content changes, and, when an preempting content change is identified, to determine whether the preempting content change is tolerable or within tolerance—a local weather event, a Presidential race report, a terrorist act, a sporting event, etc.).

Alternatively, if the select broadcast content were “similar” content, content detecting controller 206 identifies the defined set of select broadcast content as substantially similar to a prior defined set of select broadcast content (whether from temporally disparate segments of a single broadcast content stream or across multiple broadcast content streams). For instance, if a user/subscriber were interested in a particular television show genera, such as a situation comedy (e.g., SIENFELD™), monitoring system 100 may suitably be programmed to find other similar television (or radio, Internet or other) broadcast content, such as another situation comedy about a group of friends (e.g., CHEERS™, FRIENDS™, etc.)

Alternatively, according to a related embodiment, if the select broadcast content is “similar” content, and the application/implementation was further operable to update/modify stored content (including the functionality of deleting redundant content), content detecting controller 206 is further operable to (i) maintain the prior defined set of select broadcast content in memory and (ii) modify the prior defined set of select broadcast content as a function of the defined set of select broadcast content. For instance, if a user/subscriber were interested in a Presidential election, monitoring system 100 may suitably be programmed to at least one of update the prior defined set of data related to the same with more current information or save the new/current defined set and delete any redundant data concerning the election race.

For purposes of illustration, it is advantageous to continue with the “Live Alert” example introduced above, wherein monitoring system 100 receives a preempting “breaking news” interruption during an otherwise scheduled program. Upon the occurrence of the “Live Alert,” content detecting controller 106, which is responsive to content monitoring controller 105, operates to process each sensed change as a function of associated threshold values to determine whether the change is within tolerance, meaning has not exceeded a threshold.

In the event that a threshold-exceeding “Live Alert” is sensed, then a select-similar broadcast content has been detected. If appliance 200 is in “On” mode, communication of the “Live Alert” may be as simply changing a television channel, turning up the volume, or the like. If appliance 200 is in “Off” or standby/low power mode, content detecting controller 106 causes appliance 200 to switch from standby to the operational or “ON” mode. According to the present example, channel selection controller(s) 260 associated with switched-ON receiver may cause appliance to tune to a default or selected emergency channel. Optionally, channel selection controller 260 may cause the tuner to set the volume of the radio or television to a “HIGH” level for emergency notification purposes. Optionally, appliance 200 may be caused to play or display (as applicable) a prerecorded or transmitted audio or video message(s) associated with the detected “Live Alert.”

The detection of “live Alerts” or special events may suitably be based, at least in part, upon at least one subscriber profile. This related invention is disclosed in U.S. patent application Ser. No. [Docket No. 701483], filed concurrently herewith, entitled “SYSTEMS FOR MONITORING BROADCAST CONTENT AS A FUNCTION OF SUBSCRIBER PROFILES AND METHODS OF OPERATING THE SAME.” The disclosure of this related patent application is incorporated by reference for all purposes as if fully set forth herein.

Although the present invention has been described in detail, those skilled in the art should understand that they can make various changes, substitutions and alterations herein without departing from the spirit and scope of the invention in its broadest form.

What is claimed is:

1. A monitoring system capable of identifying content similarity within a plurality of broadcast content streams, each of said plurality of broadcast content streams having detectable content attributes, said monitoring system operable to (i) monitor said plurality of broadcast content streams, and (ii) compare a first segment and a second segment of at least one broadcast content stream to identify select-similar broadcast content within said segments as a function of ones of said detectable content attributes.

2. The monitoring system for identifying content similarity within a plurality of broadcast content streams as set forth in claim 1 further comprising a content monitoring controller that is operable to (i) receive said plurality of broadcast content streams from at least one receiver, (ii) monitor said plurality of received broadcast content streams, and (iii) sense content changes in said plurality of received broadcast content streams as a function of said detectable content attributes.

3. The monitoring system for identifying content similarity within a plurality of broadcast content streams as set forth in claim 1 further comprising a content detecting controller that identifies select broadcast content as a function of ones of said detectable content attributes, said content detecting controller operable to identify a defined set of select broadcast content as a function of ones of said detectable content attributes associated with said select broadcast content.

4. The monitoring system for identifying content similarity within a plurality of broadcast content streams as set forth in claim 3 wherein said content detecting controller is further operable to identify said defined set of select broadcast content as unscheduled broadcast content that preempts scheduled broadcast content.

5. The monitoring system for identifying content similarity within a plurality of broadcast content streams as set forth in claim 3 wherein said content detecting controller is further operable to identify said defined set of select broadcast content as substantially similar to a prior defined set of select broadcast content.

6. The monitoring system for identifying content similarity within a plurality of broadcast content streams as set forth in claim 5 wherein said content detecting controller is further operable to maintain said defined set of select broadcast content in memory.

7. The monitoring system for identifying content similarity within a plurality of broadcast content streams as set forth in claim 5 wherein said prior defined set of select broadcast content is maintained in memory and said content detecting controller is further operable to modify said prior defined set of select broadcast content as a function of said defined set of select broadcast content.

8. The monitoring system for identifying content similarity within a plurality of broadcast content streams as set forth in claim 3 wherein said content detecting controller is further operable to define at least one threshold value that is associated with said detectable content attributes of said select broadcast content.

9. The monitoring system for identifying content similarity within a plurality of broadcast content streams as set forth in claim 1 wherein at least one of said received broadcast content streams comprises a plurality of video frames and said monitoring system further operable to (i) extract image text from said plurality of video frames, (ii) determine at least one attribute of said extracted image text, and (iii) compare said at least one extracted image text attribute and at least one of said detectable content attributes.

10. The monitoring system for identifying content similarity within a plurality of broadcast content streams as set forth in claim 1 wherein said monitoring system is further operable to identify two temporally disparate sets of select broadcast content within one of said plurality of broadcast content streams.

11. The monitoring system for identifying content similarity within a plurality of broadcast content streams as set forth in claim 1 wherein said monitoring system is further operable to identify two disparate sets of select broadcast content within two of said plurality of broadcast content streams.

12. The monitoring system for identifying content similarity within a plurality of broadcast content streams as set forth in claim 1 wherein said monitoring system is further operable to generate a control signal as a function of said identified select broadcast content.

13. The monitoring system for identifying content similarity within a plurality of broadcast content streams as set forth in claim 12 wherein said monitoring system is associated with an appliance, said generated control signal directs operation of said appliance.

14. The monitoring system for identifying content similarity within a plurality of broadcast content streams as set forth in claim 13 wherein said associated appliance is capable of operating in one of an active mode and a standby mode and, when said appliance is operating in said standby mode, said generated control signal directs said associated appliance to switch from said standby mode to said active mode.

15. The monitoring system for identifying content similarity within a plurality of broadcast content streams as set forth in claim 1 wherein said monitoring system is further operable to monitor at least one of audio content, video content and textual content within said plurality of broadcast content streams.

16. The monitoring system for identifying content similarity within a plurality of broadcast content streams as set forth in claim 15 wherein said monitoring system identifies said select-similar content broadcast within at least one of said plurality of broadcast content streams as a function of said at least one of audio content, video content and textual content.

17. The monitoring system for identifying content similarity within a plurality of broadcast content streams as set forth in claim 15 wherein ones of said detectable content attributes include a transcript of said at least one of audio content, video content and textual content, and monitoring system identifies said select-similar content broadcast within at least one of said plurality of broadcast content streams as a function of said transcript.

18. The monitoring system for identifying content similarity within a plurality of broadcast content streams as set forth in claim 1 wherein said monitoring system (i) monitors said plurality of broadcast content streams using at least one similarity processor to identify similar broadcast content, and (ii) compares said first segment and said second segment of said at least one broadcast content stream using at least one compare content processor to identify said select-similar broadcast content.

19. A method of operating a monitoring system to identify content similarity within a plurality of broadcast content streams having detectable content attributes, said method operating said monitoring system comprising the steps of:
monitoring said plurality of content streams received from at least one broadcast source; and
compare a first segment and a second segment of at least one broadcast content stream to identify select-similar broadcast content within said segments as a function of ones of said detectable content attributes.

20. The method of operating said monitoring system as set forth in claim 19 further comprising the steps of:
receiving said plurality of broadcast content streams from at least one receiver;
monitoring said plurality of received broadcast content streams; and
sensing content changes in said plurality of received broadcast content streams as a function of said detectable content attributes.

21. The method of operating said monitoring system as set forth in claim 19 further comprising the step of identifying a defined set of select broadcast content as a function of ones of said detectable content attributes associated with said select broadcast content.

22. The method of operating said monitoring system as set forth in claim 21 further comprising the step of identifying said defined set of select broadcast content as unscheduled broadcast content that preempts scheduled broadcast content.

23. The method of operating said monitoring system as set forth in claim 21 further comprising the step of identifying said defined set of select broadcast content as substantially similar to a prior defined set of select broadcast content.

24. The method of operating said monitoring system as set forth in claim 23 further comprising the step of maintaining said defined set of select broadcast content in memory.

25. The method of operating said monitoring system as set forth in claim 23 wherein said prior defined set of select broadcast content is maintained in memory, and said method further comprises the step of modifying said prior defined set of select broadcast content as a function of said defined set of select broadcast content.

26. The method of operating said monitoring system as set forth in claim 21 further comprising the step of defining at least one threshold value that is associated with said detectable content attributes of said select broadcast content.

27. The method of operating said monitoring system as set forth in claim 26 wherein at least one of said received broadcast content streams comprises a plurality of video frames, and said method further comprises the steps of:
extracting image text from said plurality of video frames;
determining at least one attribute of said extracted image text, and
comparing said at least one extracted image text attribute and at least one of said detectable content attributes.

28. The method of operating said monitoring system as set forth in claim 19 further comprising the step of identifying two temporally disparate sets of select broadcast content within one of said plurality of broadcast content streams.

29. The method of operating said monitoring system as set forth in claim 19 further comprising the step of identifying two disparate sets of select broadcast content within two of said plurality of broadcast content streams.

30. The method of operating said monitoring system as set forth in claim 19 further comprising the step of generating a control signal as a function of said identified select broadcast content.

31. The method of operating said monitoring system as set forth in claim 30 wherein said monitoring system is associated with an appliance and said generated control signal directs operation of said appliance.

32. The method of operating said monitoring system as set forth in claim 31 wherein said associated appliance is capable of operating in one of an active mode and a standby mode and, when said appliance is operating in said standby mode, said generated control signal directs said associated appliance to switch from said standby mode to said active mode.

33. The method of operating said monitoring system as set forth in claim 19 further comprising the step of monitoring at least one of audio content, video content and textual content within said plurality of broadcast content streams.

34. The method of operating said monitoring system as set forth in claim 33 further comprising the step of identifying said select-similar content broadcast within at least one of said plurality of broadcast content streams as a function of said at least one of audio content, video content and textual content.

35. The method of operating said monitoring system as set forth in claim 19 wherein ones of said detectable content attributes include a transcript of said at least one of audio content, video content and textual content, and said method further comprises the step of identifying said select-similar content broadcast within at least one of said plurality of broadcast content streams as a function of said transcript.

36. The method of operating said monitoring system as set forth in claim 33 further comprising the steps of (i) using at least one similarity processor to identify similar broadcast content while monitoring said plurality of broadcast content streams using, and using at least one compare content processor to identify said select-similar broadcast content while comparing said first segment and said second segment of said at least one broadcast content stream.

37. An appliance comprising:
a receiver capable of receiving broadcast content streams; and
a monitoring system capable of identifying content similarity within a plurality of broadcast content streams, each of said plurality of broadcast content streams having detectable content attributes, said monitoring system operable to (i) monitor said plurality of broadcast content streams, and (ii) compare a first segment and a second segment of at least one broadcast content stream to identify select-similar broadcast content within said segments as a function of ones of said detectable content attributes.

38. The appliance as set forth in claim 37 wherein said monitoring system further comprises a content monitoring controller that is operable to (i) receive said plurality of broadcast content streams from at least one receiver, (ii) monitor said plurality of received broadcast content streams, and (iii) sense content changes in said plurality of received broadcast content streams as a function of said detectable content attributes.

39. The appliance as set forth in claim 37 wherein said monitoring system further comprises a content detecting controller that identifies select broadcast content as a function of ones of said detectable content attributes, said content detecting controller operable to identify a defined set of select broadcast content as a function of ones of said detectable content attributes associated with said select broadcast content.

40. The appliance as set forth in claim 39 wherein said content detecting controller is further operable to identify said defined set of select broadcast content as unscheduled broadcast content that preempts scheduled broadcast content.

41. The appliance as set forth in claim 39 wherein said content detecting controller is further operable to identify said defined set of select broadcast content as substantially similar to a prior defined set of select broadcast content.

42. The appliance as set forth in claim 41 wherein said content detecting controller is further operable to maintain said defined set of select broadcast content in memory.

43. The appliance as set forth in claim 42 wherein said prior defined set of select broadcast content is maintained in memory and said content detecting controller is further operable to modify said prior defined set of select broadcast content as a function of said defined set of select broadcast content.

44. The appliance as set forth in claim 39 wherein said content detecting controller is further operable to define at least one threshold value that is associated with said detectable content attributes of said select broadcast content.

45. The appliance as set forth in claim 37 wherein at least one of said received broadcast content streams comprises a plurality of video frames and said monitoring system further operable to (i) extract image text from said plurality of video frames, (ii) determine at least one attribute of said extracted image text, and (iii) compare said at least one extracted image text attribute and at least one of said detectable content attributes.

46. The appliance as set forth in claim 37 wherein said monitoring system is further operable to identify two temporally disparate sets of select broadcast content within one of said plurality of broadcast content streams.

47. The appliance as set forth in claim 37 wherein said monitoring system is further operable to identify two disparate sets of select broadcast content within two of said plurality of broadcast content streams.

48. The appliance as set forth in claim 37 wherein said monitoring system is further operable to generate a control signal as a function of said identified select broadcast content, said generated control signal directing operation of said appliance.

49. The appliance as set forth in claim 48 wherein said appliance is capable of operating in one of an active mode and a standby mode and, when said appliance is operating in said standby mode, said generated control signal directs said appliance to switch from said standby mode to said active mode.

50. The appliance as set forth in claim 37 wherein said monitoring system is further operable to monitor at least one of audio content, video content and textual content within said plurality of broadcast content streams.

51. The appliance as set forth in claim 50 wherein said monitoring system identifies said select-similar content broadcast within at least one of said plurality of broadcast content streams as a function of said at least one of audio content, video content and textual content.

52. The appliance as set forth in claim 50 wherein ones of said detectable content attributes include a transcript of said at least one of audio content, video content and textual content, and monitoring system identifies said select-similar content broadcast within at least one of said plurality of broadcast content streams as a function of said transcript.

53. The appliance as set forth in claim 37 wherein said monitoring system (i) monitors said plurality of broadcast content streams using at least one similarity processor to identify similar broadcast content, and (ii) compares said first segment and said second segment of said at least one broadcast content stream using at least one compare content processor to identify said select-similar broadcast content.

54. A control signal detectable by an appliance, said control signal generated by the steps of:
monitoring a plurality of broadcast content streams having detectable content attributes, said plurality of broadcast content streams received from at least one broadcast source; and
comparing a first segment and a second segment of at least one broadcast content stream to identify select-similar broadcast content within said segments as a function of ones of said detectable content attributes.

55. The control signal as set forth in claim 54 wherein said generated control signal directs operation of said appliance.

56. The control signal as set forth in claim 55 wherein said associated appliance is capable of operating in one of an active mode and a standby mode and, when said appliance is operating in said standby mode, said generated control signal directs said associated appliance to switch from said standby mode to said active mode.
